(19) United States
(12) Patent Application Publication
(10) Pub. No.: US 2018/0300773 A1
(43) Pub. Date: Oct. 18, 2018

(54) METHOD FOR PROVIDING TRAVEL INFORMATION, AND INFORMATION SYSTEM

(71) Applicant: SIEMENS AKTIENGESELLSCHAFT, MUENCHEN (DE)

(72) Inventor: JENS-HARRO OECHSNER, DENKTE OT NEINDORF (DE)

(21) Appl. No.: 15/767,697

(22) PCT Filed: Sep. 16, 2016
(86) PCT No.: PCT/EP2016/071915

§ 371 Date: Apr. 12, 2018

(30) Foreign Application Priority Data
Oct. 12, 2015 (DE) 10 2015 219 692.5

(51) Int. Cl. G06Q 30/02; G08G 1/127; B61L 25/02; G07C 5/00; G06K 9/00

(52) U.S. Cl. CPC G06Q 30/0281; G08G 1/127; G06Q 50/30; G07C 5/008; G06K 9/00838; B61L 25/02

(57) ABSTRACT

A method provides travel information, in which travel information relating to a vehicle is provided and is transmitted between a mobile device and a central computer. In order to achieve an improved method for providing travel information, it is proposed that, before providing the travel information, the vehicle for which the travel information is provided is determined using the mobile device in an automated manner.

The invention relates to a method for providing travel information, in which travel information relating to a vehicle is provided and transferred between a mobile device and a central computer.

Travel information relating to a vehicle is provided in a wide variety of ways. Thus, for example, for rail customers, travel information relating to a train is provided by way of electronic display boards and/or loudspeakers. Travel information of this kind may include, for example, information on any delay to the train and/or on a different departure platform of the train from that in a timetable.

Nowadays, travel information may also be provided by using a mobile device such as a smartphone. Thus, for example, a rail customer may use their mobile device to call up information relating to a departure time and/or a departure platform of a train from a central computer of a train operator. This information is then transmitted to the mobile device from the central computer. Conversely, it is also possible for the rail customer to use their mobile device to transmit travel information to the central computer of the train operator, for example when booking a ticket and/or a seat.

From the point of view of the customers of a vehicle operator, it is desirable for travel information relating to a vehicle to be providable in a simple manner using a mobile device, in particular without having to perform multiple inputs to the mobile device.

Moreover, from the point of view of the customers, there is a desire to be able to exchange with the vehicle operator as much information as possible that will allow the use of a vehicle of the vehicle operator to be made more convenient for the customers.

It is an object of the invention to provide an improved method for providing travel information.

This object is achieved by a method of the type mentioned in the introduction, in which, according to the invention, using the mobile device, before the travel information is provided the question of for which vehicle the travel information is provided is established automatically.

As a result of previously and automatically establishing for which vehicle the travel information is to be provided, or is provided after this is established, provision of the travel information is simplified, in particular for a user of the mobile device. Thus, for example, it is possible to dispense with the user of the mobile device having to manually enter a plurality of data or parameters into the mobile device in order to be able to establish for which vehicle the travel information is to be provided.

As a result of this automatic establishing, the user of the mobile device can further obtain the travel information more quickly and/or the travel information can be transmitted to the vehicle operator more quickly. This may be advantageous in particular in situations in which the user of the mobile device has little time to request and/or transmit the travel information.

A situation of this kind may be the case for example if the user, shortly before a train arrives in a station, wishes to request travel information relating to this train and would like this information already to be output before the arrival of the train at the station. A situation of this kind may further be the case for example if the user of the mobile device would like to book a ticket for the train and/or a seat as the train is already arriving in the station or is already at the station.

The invention makes it possible to increase the level of convenience of the user of the mobile device in respect of providing the travel information and in particular in respect of the amount of the travel information.

The term “travel information” in the present document may include information that relates to a (planned) journey or travel by a vehicle. The travel information may include among other things information for locating the vehicle, information relating to an arrival and/or departure time of the vehicle, information on travel destinations of the vehicle, information on whether an individual needs help in boarding the vehicle, and/or further information.

Establishing for which vehicle the travel information is to be provided or is provided may be fully or partly automatic. In the case of establishing it fully automatically, it is preferably determined for which vehicle the travel information is to be provided without human intervention. In the case of establishing it partly automatically, an automatically generated preselection of one or more vehicles may for example be output by way of the mobile device. The user of the mobile device may then select, from the preselection, a vehicle for which the travel information is to be provided.

The user of the mobile device may in particular be an individual who would like to use the vehicle as a passenger. However, the user of the mobile device need not necessarily (already) be inside the vehicle.

The vehicle for which the travel information is provided may be among other things a public transport vehicle. For example, the vehicle may be a bus, in particular a long-distance bus. As an alternative, the vehicle may be a rail vehicle. The term “rail vehicle” below may include an individual rail car or a rail vehicle set having a plurality of rail cars.

Where the text below (including in the claims) refers to a station, this may in particular be understood to mean a station for a rail vehicle, a bus station or a stop for a rail vehicle or for a bus.

The travel information may relate to a vehicle that is already in a station or a vehicle that will be (in the future) arriving at the station. The station is favorably the station at which the mobile device is located.

Furthermore, it is possible for the vehicle to be a passenger car, in particular a rental car or a car-pool car. In this case, the travel information may for example be used to locate a car-pool car or a rental car on a site of the vehicle operator.

Preferably, the travel information relates to a vehicle from a group of a plurality of vehicles. Using the mobile device, it is thus favorably established for which vehicle from this group the travel information is provided. The group of vehicles may include for example some or all of the vehicles of the vehicle operator, in particular at a predetermined location.

The travel information may contain among other things data or information on at least one third-party system, such as a timetable system, an interlocking, a centralized control system and/or a ticket booking system, or may be based on data or information from at least one third-party system of this kind.

The transfer of travel information between the mobile device and the central computer may include transmitting at least some of the travel information from the central computer to the mobile device. In this way, the travel information or this part of the travel information may be provided to the mobile device. As an alternative or in addition, it is possible for at least some of the travel information to be transmitted from the mobile device to the central computer. As a result, the travel information or this part of the travel information is provided to the central computer.

Favorably, the travel information is transferred wirelessly between the mobile device and the central computer, in particular by way of WLAN, Bluetooth and/or mobile radio.

The central computer may be for example a computer of the vehicle operator. Preferably, the central computer is a non-mobile computer—that is to say one that is arranged at a fixed location. The central computer may be arranged for example at a station or in the vicinity of a station. Moreover, the central computer favorably has a data transfer unit for wireless data transfer. Favorably, the central computer is intended to evaluate and process data or information that is provided thereto by the mobile device and/or a third-party system.

The mobile device, also called a mobile terminal, may for example be a smartphone, a tablet computer, a personal digital assistant, a notebook or smart glasses.

Favorably, when the method is carried out the mobile device is located in the station or in the vicinity of the station, for example at a distance of at most 1 km, preferably at most 100 m, from the station. This is advantageous in particular if a communications connection between the mobile device and the central computer has a relatively small range.

Furthermore, it is favorable if the mobile device has a data transfer unit, a location determining unit, a display unit, a microphone, a speaker, a vibration unit and/or a camera.

The data transfer unit of the mobile device is preferably intended for wireless data transfer, in particular by WLAN, Bluetooth and/or mobile radio.

The location determining unit of the mobile device may further be based on GPS, in particular indoor GPS, or a similar system. As an alternative or in addition, the location determining unit of the mobile device may be intended to determine signal propagation delays and/or signal strengths of signals that are transferred between the mobile device and at least one location unit arranged at the station. On the basis of the signal propagation delays and/or signal strengths, a location of the mobile device may be determined. The location determining unit may further be intended to receive WLAN signals and in particular to measure the signal strength thereof. Thus, for example, the location of the mobile device may be determined using WLAN signals that are transmitted by one or more WLAN transmitters in the station.

Moreover, it is possible to precisely determine a distance and an orientation of the mobile device in three dimensions with respect to a movable device, such as a vehicle and/or another mobile device, or with respect to a device having a fixed location in the station, using a scale of different combinations of technical classes, frequencies (bands of 2.4 GHz, 5.0 GHz, 60.0 GHz), channels, standards (IEEE 802.11), variants (b, g, n, a, h, ac and ad) and/or dynamic adjustment of a transmitting power of the mobile device.

The display unit of the mobile device may for example take the form of a combined display input unit, in particular a touch display. In particular if the mobile device takes the form of smart glasses, the display unit may include a projector that is intended to project or overlay information into a person's field of view.

Moreover, the travel information may relate to a station, in particular a station at which the vehicle is to arrive or has arrived and/or from which the vehicle is to depart. The travel information advantageously relates to the station at/in which the mobile device is located, and/or at/in which the central computer is located.

In an advantageous embodiment of the invention, establishing for which vehicle the travel information is provided is performed using image recognition. Preferably, the mobile device is used to record an image of an object that contains information relating to the vehicle. For this image, favorably image recognition is carried out. The vehicle can then be identified using the image recognition. Moreover, the image recognition may include, among other things, text recognition.

The image recognition enables the vehicle for which the travel information is to be provided to be established quickly and reliably. In particular here, it is possible to avoid the user of the mobile device having to manually enter information relating to the vehicle into the mobile device so that the vehicle for which the travel information is to be provided can be established.

Recording the image need not necessarily include storage of the image and/or release of a shutter of the camera of the mobile device. The image for which image recognition is carried out may for example be a preview image. In the present document, the term “preview image” may include an image that is captured or recorded by the camera of the mobile device and displayed on the display unit of the mobile device as a preview, before the shutter of the camera is released.

The object that includes the information relating to the vehicle may be for example a display board or another object at the station. Moreover, the object that includes the information relating to the vehicle may be a ticket. That is to say that the image may for example be recorded from a ticket for the vehicle or from a part of the ticket, in particular the QR code thereof.

Advantageously, during image recognition an identifier of the vehicle or—put more generally—an item of information that can be unambiguously associated with the vehicle is determined. On the basis of the identifier or an item of information of this kind, the vehicle can be unambiguously identified. The identifier of the vehicle may relate for example to a (line) number of the vehicle, a timetabled departure time of the vehicle from a predetermined station, and/or a timetabled arrival time of the vehicle at a predetermined station.

The data or information that is determined by the image recognition may further be linked, filtered and/or plausibility checked automatically.

It may be provided for a prompt, as to whether the identified vehicle is the vehicle for which travel information is to be provided, to be output to the mobile device before the travel information relating to the vehicle identified from the image recognition is provided. In this way, the possibility that the travel information relating to a vehicle other than that desired by the user of the mobile device is erroneously provided can be avoided. Once the user of the mobile device issues a confirmation, advantageously the travel information relating to the vehicle identified from the image recognition is provided.

Moreover, it is possible for the vehicle for which the travel information is to be provided to be determined by automatically reading off and evaluating a digital file stored in the mobile device, such as an electronic ticket. The file may be read off and evaluated among other things in the mobile device itself. The file may further be read off and evaluated in the central computer once the file has been transmitted from the mobile device to the central computer.

According to an advantageous development of the invention, establishing for which vehicle the travel information is provided is performed using a location recognition, in particular a radio-based location recognition. Advantageously, during the location recognition a location of the mobile device is determined. Using the location of the mobile device, it is in turn possible to determine at which platform, in particular which track of a platform, or which stop the mobile device is located. The location of the mobile device may for example be determined with the aid of the location determining unit of the mobile device.

The location recognition also enables the vehicle for which the travel information is to be provided to be established quickly and reliably. In particular here, it is possible to avoid the user of the mobile device having to manually enter information relating to the vehicle into the mobile device so that the vehicle for which the travel information is to be provided can be established.

It may for example be provided for the travel information to be provided in relation to the vehicle to depart next from the platform or the stop at which the mobile device is located.

It may further be provided for a preselection to be generated of the vehicles that are to depart from or arrive at this platform or stop within a predetermined period, in particular listed by their arrival and/or departure time. The user of the mobile device can then select the vehicle for which the travel information is to be provided from this preselection. By way of a plausibility check in which, in addition to the location of the mobile device, further parameters or items of information are evaluated, the preselection may be limited, in particular to a few vehicles or even to a single vehicle.

Preferably, using the mobile device it is possible to determine automatically for which platform the travel information is to be provided. Determining for which platform the travel information is to be provided may among other things be performed using image recognition, in which for example a recorded image of an object at the station, in particular an image of a board with the name of the station, is analyzed. Determining for which station the travel information is to be provided may further be performed using the above-described location recognition, in which the location of the mobile device is determined.

Moreover, it is preferred if at least some of the travel information is provided to the mobile device. This makes it possible for the user of the mobile device to access and/or read off this part of the travel information. Favorably, this part of the travel information is output via the mobile device visually, acoustically and/or in the form of a vibration signal. It may further be provided for at least this part of the travel information to be displayed on the mobile device in the form of a website, in particular a personalized website. Preferably, the type of output—that is the format of the output—is adjustable in the mobile device. For example, this part of the travel information may be output on the display unit of the mobile device and/or through the speaker of the mobile device.

Moreover, it may be provided for at least some of the travel information to be output by way of a non-mobile output unit, in particular an output unit arranged in the station, such as a screen, a loudspeaker and/or a projection unit.

Preferably, the user of the mobile device may set which part of the travel information is to be output by way of the mobile device, for example by a presetting stored in the mobile device, or by a prompt before each output of the travel information. That is to say that filtering of the travel information to be output may advantageously be carried out. This makes it possible for the user of the mobile device to disable output of the part of the travel information that is irrelevant to them, as a result of which the output part of the travel information can be displayed more clearly and/or grasped more readily.

Moreover, it is preferred if the user of the mobile device can set the language in which at least some of the travel information is to be output, in particular output acoustically and/or in text form. It may further be provided for at least some of the travel information to be translated into a predeterminable language before this part of the travel information is output. Preferably, the translation is performed in real time, wherein the translation may be performed offline—that is to say in the mobile device itself—or online—that is to say with the aid of an external service. Moreover, it is preferred, in the case of an output of at least some of the travel information in text form, if a font size may be set.

As mentioned above, it is advantageous if the location of the mobile device is determined. It is further advantageous if an orientation of the mobile device is determined. At least some of the travel information may be dependent on the location and/or orientation of the mobile device. In this way, it is possible for example for the user of the mobile device to be provided with location-specific information, in particular locating information. Preferably, this part of the travel information may be automatically adapted if the location and/or orientation of the mobile device change.

For the purpose of determining the orientation of the mobile device, at least one sensor, in particular a sensor arranged in the mobile device, may be used. The sensor may for example be a magnetic field sensor by means of which the (local) orientation of the Earth's magnetic field is determined. Using the determined (local) orientation of the Earth's magnetic field, the orientation of the mobile device may in turn be determined.

The location and/or orientation of the mobile device may change for example because the user of the mobile device moves, and/or the user moves the mobile device by shifting their arm.

If the mobile device, in particular the camera of the mobile device, is pointed at a track or a stop, the travel information relating to a vehicle that is already located at this track or stop or that is to arrive at this track or stop can be provided. If the mobile device, in particular the camera of the mobile device, is then pointed at a different track or stop, then the travel information relating to a vehicle that is located at this other track or stop or that is to arrive at this other track or stop can be provided. In this way, the user of the mobile device may change their selection of the vehicle for which the travel information is to be provided simply by swiveling the camera.

Moreover, the location and/or orientation of the mobile device may be used for checking the plausibility of locating information. Moreover, the location and/or orientation of the mobile device may be used to confirm a correct location of the mobile device. In this way, for example, it is possible to check, using the location and/or orientation of the mobile device, whether the mobile device is in its previously established departure position—that is to say at an established stop or platform. If the location of the mobile device differs from the previously established departure position, for example because the vehicle arrives (at short notice) at a different platform or track or stop than that timetabled, the mobile device can signal this by a predetermined vibration signal, a corresponding visual representation and/or a predetermined acoustic signal.

Moreover, the travel information may among other things include a timetabled arrival time of the vehicle at the station, an expected arrival time of the vehicle at the station, an expected length of time until the vehicle arrives at the station, and/or a distance of the vehicle from the station. As an alternative or in addition, the travel information may include a timetabled departure time of the vehicle from the station, an expected departure time of the vehicle from the station, an expected length of time until the vehicle departs from the station.

The expected arrival and/or departure time may take into account any delay to the vehicle by comparison with a timetable. Likewise, the expected length of time until the vehicle arrives at the station and/or the expected length of time until the vehicle departs from the station may take into account any delay to the vehicle in relation to a timetable. The length(s) of time until the vehicle arrives and/or departs may in particular be output in the form of a countdown on the mobile device. Preferably, the format in which the respective time or length of time is output is settable.

Moreover, it is favorable if the travel information includes an item of information relating to a reserved seat and/or a ticket. An item of information of this kind relating to a reserved seat or a ticket is preferably transmitted to the central computer from the mobile device.

It is further preferred if the travel information includes information relating to a seat occupancy of the vehicle. Favorably, this information is output by way of the mobile device.

The information relating to the seat occupancy may be information on a total number of seats in the vehicle and/or a number of occupied and/or reserved seats in the vehicle. Moreover, the information relating to the seat occupancy may be information on free seats, in particular information on seat numbers, car numbers, car class (first or second class) and/or type of seat (aisle seat or window seat) of the free seats. The term “free seat” may in particular include a seat that is neither occupied by an individual nor reserved. On the basis of the information relating to the seat occupancy, the user of the mobile device may for example decide which car of the vehicle they would like to board.

Preferably, the seat occupancy of the vehicle is determined using seat sensors that are arranged in seats in the vehicle. The seat sensors may take the form for example of pressure sensors. As an alternative or in addition, the seat occupancy of the vehicle may be determined using cameras that are arranged in the vehicle. Here, in particular an image recognition may be utilized.

The travel information may further include information relating to a position of the vehicle in the car order. Favorably, this information is output by way of the mobile device. Furthermore, it may be provided for an alert to be output by way of the mobile device if the position of the vehicle in the car order differs from its timetabled position.

Moreover, the travel information may include an announcement made at the station relating to the vehicle, in particular an announcement made previously in the form of a loudspeaker transmission through a station loudspeaker. Preferably, this announcement is output by way of the mobile device, in particular in text form and/or acoustically. This allows the user of the mobile device to output an announcement that they did not hear or heard only in part.

The announcement may in particular be an announcement in respect of a deviation from a timetable. For example, the announcement may include information on an expected delay, an expected arrival time and/or a change in the arrival/departure track or a change to a stop. The announcement may further in particular be output repeatedly. Moreover, a plurality of such announcements that come one after the other may be output by way of the mobile device.

It is particularly preferred if at least some of the travel information is output in the form of a so-called augmented reality output. For example, using a projector of the mobile device, in particular the above-mentioned projector, at least some of the travel information may be projected into a field of view of the user of the mobile device or into a partial region of their field of view. Furthermore, at least some of the travel information may be overlaid onto an image that is recorded by a camera of the mobile device and represented in particular on the display unit of the mobile device. Preferably, part of the originally recorded image remains visible when information is overlaid. The image onto which said part of the travel information is overlaid may in particular be a preview image.

Preferably, the vehicle is a rail vehicle. It is further preferred if the user of the mobile device points the camera of the mobile device at a track in the station before the vehicle arrives at the station.

Advantageously, a representation of the vehicle that reproduces an expected stationary position of the vehicle on the track, in particular a representation of the vehicle that is correct in terms of its position and perspective, is overlaid onto the display unit of the mobile device. In this way, the user of the mobile device can for example recognize where they should wait in order to be as close as possible to an entrance door of the vehicle when the vehicle comes to a stop. Usefully, the travel information includes an item of information relating to the expected stationary position of the vehicle on this track.

The term “expected stationary position of the vehicle” may include a position in which the vehicle is expected to come to a standstill on the track. Preferably, the expected stationary position is determined from data of the vehicle operator. The term “representation of the vehicle that is correct in terms of its position and perspective” may be understood to mean a representation in which the vehicle, in particular in its expected stationary position, is represented correctly in relation to the position of the mobile device and an orientation of the view field of the camera. With a representation of the vehicle that is correct in terms of its position and perspective and that reproduces the expected stationary position of the vehicle, the vehicle is preferably represented in the position, size and perspective in which the vehicle will be seen, from the location of the user of the mobile device, when it is in its position at a standstill. If the mobile device is moved, the representation is favorably adapted to accord with the orientation and/or location of the mobile device.

Preferably, using the camera of the mobile device, an image, in particular a preview image, of the track and its surroundings is recorded. The representation of the vehicle is favorably overlaid on the recorded image, in the display unit of the mobile device.

As an alternative or in addition, a representation of the vehicle, in particular a representation of the vehicle that is correct in terms of its position and perspective, may be projected onto the field of view of the user of the mobile device using the above-mentioned projector of the mobile device.

Furthermore, it is advantageous if information relating to the seat occupancy of the vehicle is displayed in the representation of the vehicle. For example, free seats may be overlaid onto the representation of the vehicle with color highlighting, in particular being overlaid in the correct position. Moreover, occupied and/or reserved seats may be overlaid onto the representation of the vehicle with color highlighting. Free seats on the one hand and occupied and/or reserved seats on the other may in particular be highlighted in different colors. In this way, the user of the mobile device can quickly recognize which seats are free, and take this into account when making their choice of which car to board or which entrance door to use when boarding.

It is further advantageous if the representation of the vehicle is at least partly transparent so that the seats of the vehicle are at least in part recognizable in the representation. The car number, car class and/or other information may further be overlaid onto the representation of the vehicle.

Moreover, the travel information may include locating information. This may be for example information for locating the vehicle, locating a reserved seat, locating a car of the vehicle and/or locating an entrance door of the vehicle, in particular the entrance door closest to the mobile device. Moreover, the locating information may be information for locating a platform or a stop. Favorably, the locating information is output by way of the mobile device.

The locating information is preferably dependent on a position and/or orientation of the mobile device. The locating information may further be output in the form of graphical symbols such as direction arrows, or as speech instructions. It is further possible for the locating information to be output as vibration signals. A periodic or pulsing vibration may for example mean that the user of the mobile device is moving in the right direction, while a long vibration may for example mean that the user is moving in the wrong direction.

Moreover, it may be provided for a warning to be output by way of the mobile device if the user of the mobile device boards a different car of the vehicle from the car of the vehicle in which their reserved seat is located.

The locating information may further depend on a state of health and/or mobility of an individual, in particular the user of the mobile device. Favorably, the state of health and/or mobility is/are stored in the mobile device. If the individual has limited mobility, for example, this may be taken into account in the locating information. For example, the individual may be directed toward elevators instead of stairs by the locating information. It is further possible for a warning to be output by way of the mobile device if, on the way to the vehicle, the individual moves in the direction of stairs instead of toward an elevator.

Moreover, the locating information may relate to an expected stationary position of the vehicle in the station. The locating information may thus be output before the vehicle has arrived in the station. Furthermore, it is possible for the locating information to be output once the vehicle is already in the station.

The travel information may further include information on which type of help and/or which aids an individual—in particular an individual with a disability—needs to be able to reach the vehicle and/or board the vehicle, and where appropriate which type of disability the individual has. Here, it is favorable if this information is transmitted from the mobile device to the central computer.

The last-mentioned information may for example be stored or preset in the mobile device. This information may be transmitted to the central computer automatically for example, in particular as soon as the mobile device is at the platform or the stop. As an alternative, this information may be transmitted to the central computer only once it is enabled manually by the user. The vehicle operator can take measures in dependence on this information. If for example a wheelchair user transmits to the vehicle operator the information that they would like to travel by a certain train and need a wheelchair ramp to be able to board this train, the vehicle operator can send staff with a wheelchair ramp to the appropriate track.

Once the vehicle relating to which the travel information is to be provided has been established, this fact may be stored in the mobile device, at least for a predetermined length of time. In this way, it is possible for example to ensure that travel information relating to the vehicle is provided to the mobile device for a certain period without the vehicle having to be established again. Once the vehicle is established for example as described above by way of a location identifier that determines the platform or stop at which the mobile device is located, the user with the mobile device can move away from the platform or stop, with travel information relating to the vehicle continuing to be provided to the mobile device. For example, an alert relating to the upcoming arrival of the vehicle may be output by way of the mobile device a predetermined length of time before the arrival of the vehicle at the platform or stop.

The invention further relates to an information system for providing travel information.

The information system according to the invention includes a mobile device and a central computer and is intended to carry out the method according to the invention, in particular one of the developments of the method according to the invention that are described above.

Some or all of the elements mentioned above that relate to a device may be elements of this information system. In particular, the mobile device may be intended to carry out the method steps that are mentioned above in connection with the mobile device. The central computer may in turn be intended to carry out the method steps that are mentioned above in connection with the central computer.

The information system may further include at least one location determining unit by means of which a location and/or orientation of the mobile device can be determined. The location determining unit may be based on GPS, in particular indoor GPS. As an alternative or in addition, the location determining unit may include at least one locating unit, preferably a plurality of locating units. More favorably, a location of the respective locating unit is known. The locating unit(s) may in particular be arranged at a fixed location. The locating unit(s) may moreover be intended to emit and/or receive signals, in particular scalable signals, to and/or from the mobile device. The signals may be for example radio signals, in particular mobile and fixed-site radio signals.

The above description of advantageous embodiments of the invention includes numerous features of which some are reproduced grouped together in the individual subclaims. However, these features may favorably also be considered individually and be grouped together in further combinations that are useful. In particular, these features may in each case be combined individually and in any desired suitable combination with the method according to the invention and the information system according to the invention. In this way, method features may also be regarded as a property of the corresponding device unit if worded in terms of a device, and vice versa.

Although some terms are respectively used in the description and the claims in the singular or in combination with a numeral, the scope of the invention is not to be restricted to the singular or the respective numeral for these terms. Further, the words “a” and “an” should not be understood as indicative of number but as indefinite articles.

The above-mentioned properties, features and advantages of the invention, and the manner in which these are achieved, will be more clearly understood in conjunction with the description below of the exemplary embodiment of the invention, which is explained in more detail with reference to the drawings. The exemplary embodiment serves to explain the invention and does not restrict the invention to the combinations of features indicated therein, even in respect of functional features. Moreover, features of the exemplary embodiment that are suitable therefor may also be considered explicitly in isolation and combined with any one of the claims as desired.

In the drawings:

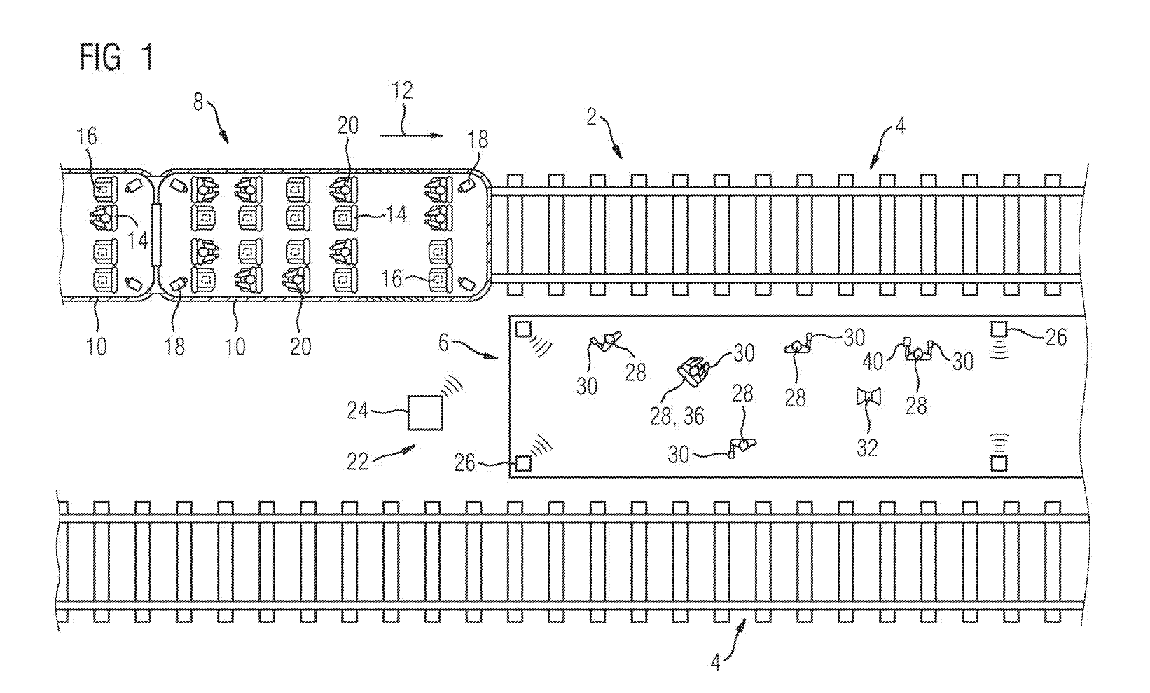

FIG. 1 shows a plan view of a station at which a rail vehicle is arriving; and

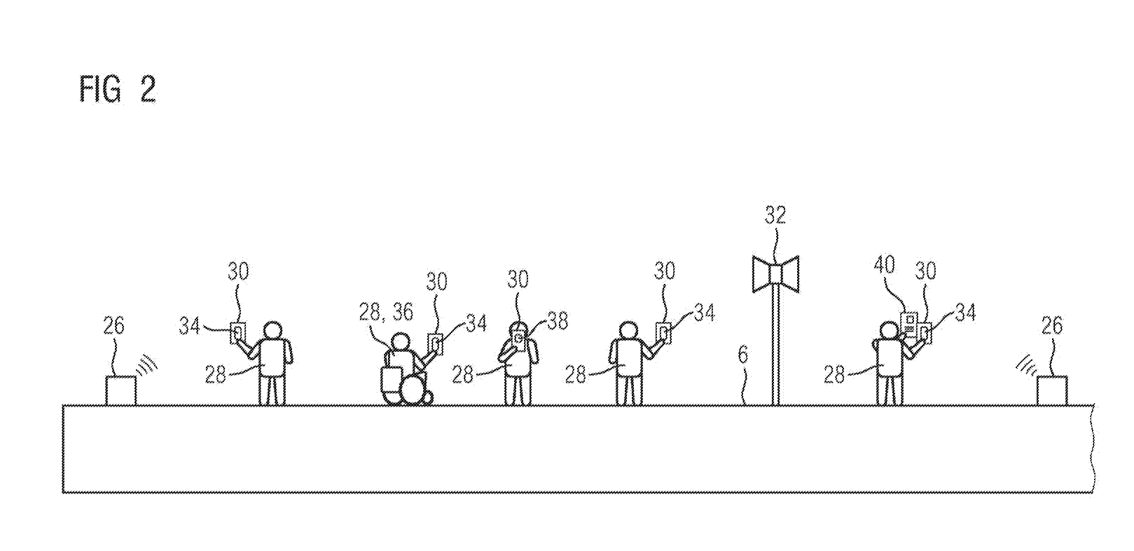

FIG. 2 shows a side view of a platform of the station from FIG. 1, where a plurality of individuals are waiting.

FIG. 1 shows a station 2 in a schematic plan view. In FIG. 1, portions of two tracks 4 of the station 2 and of a platform 6 of the station 2 that is arranged between the tracks 4 are illustrated, wherein the station 2 may have further tracks and/or further platforms that are not illustrated in the figure.

Further illustrated in FIG. 1, in a sectional illustration, is a portion of a rail vehicle 8 having a plurality of cars 10 coupled to one another. The rail vehicle 8 arrives at the station 2 on the one of the two tracks 4 that is shown at the top of the drawing, wherein its direction of travel 12 is represented in the form of an arrow.

The rail vehicle 8 further has a plurality of passenger seats 14, wherein a seat sensor 16 is arranged in each of the passenger seats 14. The seat sensors 16 take the form of pressure sensors and are intended to determine, on the basis of a pressure exerted on the respective seat sensor 16, whether an individual is sitting on the respective passenger seat 14 and/or an item of baggage has been put down there. Moreover, in each case a plurality of video cameras 18 is arranged in the individual cars 10 of the rail vehicle 8.

In the present exemplary embodiment, a plurality of passengers 20 is located in the rail vehicle 8, each sitting on one of the passenger seats 14 of the rail vehicle 8, wherein only some of the passengers 14 of the rail vehicle 8 are occupied by the passengers 20.

Furthermore, an information system 22 for providing travel information is illustrated. The information system 22 includes a non-mobile central computer 24 that is arranged in the station 2 in the vicinity of the platform 6. The information system 22 moreover includes a plurality of mutually spaced locating units 26 that are arranged at a fixed location on the platform 6 and are intended to emit and receive radio signals.

There are a plurality of individuals 28 on the platform 6. Each of the individuals 28 has a mobile device 30, which by way of example takes the form of a smartphone, in their hand. The mobile devices 30 of the individuals 28 are intended to exchange data with the central computer 24 wirelessly, in particular by WLAN, Bluetooth and/or mobile radio. Furthermore, the mobile devices 30 form part of the information system 22.

Moreover, each of the mobile devices 30 is equipped with a display unit, a radio-based data transmission unit, a speaker, a microphone, a camera and a vibration unit. The display unit of the respective mobile device 30 takes the form of a touch display and is arranged on the front side thereof. The camera of the respective mobile device 30 is arranged on the rear side thereof. The mobile devices 30 each further have a magnetic field sensor.

Furthermore, a station loudspeaker 32 is arranged on the platform 6, by way of which loudspeaker transmissions may be actuated for the individuals 28 on the platform 6.

The seat sensors 16 are used to determine which of the passenger seats 14 of the rail vehicle 8 are occupied and which of the passenger seats 14 are free. The data determined in this way in relation to the seat occupancy of the rail vehicle 8 is transmitted to the central computer 24 by radio. As an alternative or in addition, the video cameras 18 may be used to determine by image recognition which of the passenger seats 14 are occupied and which free.

If the individuals 28, that is to say the users of the mobile devices 30, would like to be provided with travel information relating to a rail vehicle from the central computer 24 by way of their mobile devices 30, or if they would like to provide travel information to the central computer 24 themselves, the individuals 28 launch a program for providing travel information on their mobile devices 30.

The locating units 26 emit radio signals that are received by the mobile devices 30. Furthermore, for each radio signal received by the mobile devices 30, the latter determine the signal strength thereof, and from the respective signal strength the mobile devices 30 determine their distances from the locating units 26. The mobile devices 30 further transmit the determined distances to the central computer 24, which determines the location of the respective mobile device 30 from the distances.

Using the location of the respective mobile device 30, the central computer 24 determines at which platform 6 and which track 4 the respective mobile device 30 is located.

Moreover, each of the mobile devices 30 determines, using its magnetic field sensor, the orientation of the Earth's magnetic field at the location of the mobile device 30, and using this the mobile device 30 then determines its spatial orientation. Furthermore, each of the mobile devices 30 transmits its spatial orientation to the central computer 24.

Using the location of the respective mobile device 30, the central computer 24 automatically establishes for which rail vehicle the travel information for the respective mobile device 30 is to be provided. In the present exemplary embodiment, the mobile devices 30 are provided with travel information relating to the rail vehicle that is timetabled next to arrive at the one of the two tracks 4 of the platform by which the respective mobile device 30 is located, or to which the respective mobile device 30 is located more closely.

According to FIG. 1, four individuals 28, with their mobile devices 30, are closer to the one of the two tracks 4 that is shown at the top of the drawing. These individuals 28 are provided with travel information relating to a rail vehicle that is timetabled as the next to arrive at the track 4 that is shown at the top of the drawing—that is to say relating to the previously mentioned illustrated rail vehicle 8. Further, according to FIG. 1 one individual 28, with their mobile device 30, is closer to the one of the two tracks 4 that is shown at the bottom of the drawing. This individual 28 is provided with travel information relating to a rail vehicle that is timetabled as the next to arrive at the track 4 that is shown at the bottom of the drawing.

If the location of one of the mobile devices 30 changes, the travel information from the central computer 24 is automatically adapted to the changed location of this mobile device 30, in particular as regards the rail vehicle to which the travel information relates.

It is further possible, taking into account the orientation of the respective mobile device 30, to establish the rail vehicle for which the travel information is to be provided to the respective mobile device 30. If for example one of the mobile devices 30 is pointed, by means of its camera on the rear side, at the track 4 that is shown at the top of the drawing, the travel information may relate to a rail vehicle that is timetabled as the next to arrive at the track 4 shown at the top of the drawing. If on the other hand one of the mobile devices 30 is pointed, by means of its camera on the rear side, at the track 4 that is shown at the bottom of the drawing, the travel information can relate to a rail vehicle that is timetabled as the next to arrive at the track 4 shown at the bottom of the drawing.

The central computer 24 provides the individual mobile devices 30 with travel information relating to the respective established rail vehicle, wherein the travel information is transmitted wirelessly from the central computer 24 to the mobile devices 30.

This travel information includes among other things an expected arrival and departure time of the rail vehicle that has been established, taking into account any delay, the information relating to a car order of the rail vehicle and information on destinations of the rail vehicle. The travel information further includes information relating to a seat occupancy of the rail vehicle, in particular information on the number of free seats in each car and the seat and car numbers of the free seats.

This travel information is output by way of the mobile devices 30, in particular visually by way of the display unit 34 and/or acoustically by way of the speaker of the respective mobile device 30 (cf. FIG. 2)—depending on the presetting in the mobile device 30.

If the rail vehicle for which the travel information is provided by the central computer 24 is to arrive at another track 4 than that timetabled, then further an alert, which includes an item of information on which track 4 the rail vehicle is to arrive at, is output by way of the respective mobile device 30.

Furthermore, and as part of the travel information, the individuals 28 may previously have loudspeaker transmissions that are made over the station loudspeaker 32 relating to the respective rail vehicle output to their mobile devices 30, for example in text form and/or acoustically. The loudspeaker transmissions are provided to the mobile devices 30 by the central computer 24. For example, the loudspeaker transmissions may include information on any delay or on a car order of the established rail vehicle that differs from a timetable.

FIG. 2 shows the platform 6 of the station 2 and the individuals 28 on the platform 6 in a side view.

In the present exemplary embodiment, one of the individuals 28 is a wheelchair user 36. The wheelchair user 36 uses their mobile device 30 to provide the central computer 24 with the information that they need a wheelchair ramp to be able to board the rail vehicle 8 arriving at the station 2 (cf. FIG. 1), as travel information. That is to say that the wheelchair user 36 transmits this information to the central computer 24 by way of their mobile device 30. The operator of the rail vehicle 8 then initiates appropriate measures, for example sending staff with a wheelchair ramp to the wheelchair user 36 at the platform 6.

Furthermore, some of the individuals 28 point the camera 38 of their respective mobile device 30 at one of the two tracks 4 of the station 2 (cf. FIG. 1). Then, and before the established rail vehicle arrives at this track 4, a representation of the rail vehicle that will in the future arrive at the track 4 that is correct in terms of its position and perspective is overlaid in the display unit 34 of the respective mobile device 30, onto a preview image recorded by the camera 38. The representation of the rail vehicle reproduces its expected stationary position on the track 4, wherein information relating to the expected stationary position is a constituent part of the travel information.

The representation of the rail vehicle on the display unit 34 of the respective mobile device 30 depends on the location and orientation of the mobile device 30. If the location and/or orientation of the respective mobile device 30 changes, the representation of the rail vehicle is also changed automatically such that the representation always remains correct on the display unit 34 in terms of its position and perspective. In this way, the individuals 28 recognize—if they pan their mobile device 30 around over the track 4—how the car order of the rail vehicle will appear in its expected stationary position, and/or where the nearest entrance door of the rail vehicle will be located. Furthermore, free passenger seats 14 are overlaid in the correct position, with color highlighting, onto the representation of the rail vehicle, such that the individuals 28 can already take account of the seat occupancy of the rail vehicle when deciding which car of the rail vehicle they wish to board, before the rail vehicle arrives.

Furthermore, one of the individuals 28 is using their mobile device 30 to take an image of their ticket 40, with a seat reservation for the above-mentioned arriving rail vehicle 8. For the image of the ticket 40, the mobile device 30 of this individual 28 carries out an image recognition in which an identifier of the rail vehicle 8 and a car and seat number of the reserved passenger seat 14 is determined, wherein the mobile device 30 transmits the identifier and the car and seat number to the central computer 24. In the present case, the image recognition is used to establish that travel information for said rail vehicle 8 is to be provided.

Locating information is transmitted from the central computer 24 to the mobile device 30 of said individual 28 already before the rail vehicle 8 comes to a standstill, as part of the travel information that is output by way of the mobile device 30 of this individual 28. The locating information serves to locate the reserved passenger seat 14 and the car 10 of the rail vehicle 8 in which the reserved passenger seat 14 is located, and relates to the expected stationary position of the rail vehicle 8 at the platform 6. Furthermore, the locating information depends on the location and orientation of the mobile device 30 of this individual 28. That is to say that if the location and/or orientation of the mobile device 30 changes, automatically adapted locating information is transmitted to the mobile device 30 from the central computer 24.

The locating information may for example be output in the form of a vibration signal. If the individual 28 moves for example in the direction of the reserved passenger seat 14 (in relation to the expected stationary position of the rail vehicle 8), the vibration signal may for example be pulsed. If the individual 28 moves away from the reserved passenger seat 14, by contrast, the vibration signal may for example be a long vibration signal. As an alternative or in addition, it is possible for direction arrows for locating the reserved passenger seat 14 to be displayed on the display unit 34 of the mobile device 30 or for the reserved passenger seat 14 to be overlaid onto the above-mentioned representation of the rail vehicle 8, with color highlighting.

If the individual 28 does not board the car 10 of the rail vehicle 8 in which the reserved passenger seat 14 is located but, rather, boards a different car 10 of the rail vehicle 8, a warning is output to this individual 28 by way of their mobile device 30.

If one of the individuals 28 has no ticket and/or no seat reservation for a rail vehicle that they would like to use, the individual 28 can book a ticket and/or a seat reservation for the rail vehicle using their mobile device 30, and pay using an online payment system, while the rail vehicle is arriving at the station 2 or while the rail vehicle is already at the station 2. In a case of this kind, travel information in relation to the booking is transmitted from the mobile device 30 of this individual 28 to the central computer 24. It is possible for example to use the above-described location recognition by which it is determined which track 4 the mobile device 30 is at to determine which rail vehicle the booking relates to.

Although the invention has been illustrated and described in detail by means of the preferred exemplary embodiment, the invention is not restricted by the disclosed example, and other variations may be derived herefrom without departing from the scope of protection of the invention.

1-15. (canceled)

16. A method for providing travel information, which comprises the steps of:
automatically determining via a mobile device which vehicle the travel information is provided for; and
subsequently providing the travel information relating to the vehicle by transferring the travel information between a central computer and the mobile device.

17. The method according to claim 16, wherein the step of determining the vehicle which the travel information is provided for is performed by:
performing an image recognition, by using the mobile device to record an image of an object that contains information relating to the vehicle; and
identifying the vehicle using the image recognition.

18. The method according to claim 16, wherein the step of determining which vehicle the travel information is provided for is performed by the further step of using radio-based location recognition for determining a location of the mobile device, a platform at which the mobile device is located or a stop at which the mobile device is located.

19. The method according to claim 16, wherein at least part of the travel information is provided to the mobile device, and the part of the travel information is output via the mobile device visually, acoustically and/or in a form of a vibration signal.

20. The method according to claim 16, which further comprises determining at least one of a location or an orientation of the mobile device, at least part of the travel information is dependent on the location and/or the orientation of the mobile device, and the part of the travel information is automatically adapted if the location and/or the orientation of the mobile device change.

21. The method according to claim 16, wherein the travel information includes information relating to seat occupancy of the vehicle, and the information is output by way of the mobile device.

22. The method according to claim 21, which further comprises determining the seat occupancy of the vehicle using seat sensors that are disposed in seats in the vehicle, and/or using cameras that are disposed in the vehicle.

23. The method according to claim 16, wherein the travel information includes an announcement made at a station relating to the vehicle and the announcement is output by way of the mobile device, in text form and/or acoustically.

24. The method according to claim 16, wherein at least some of the travel information is overlaid onto an image that is recorded by a camera of the mobile device and represented on a display unit of the mobile device.

25. The method according to claim 16, wherein:
the vehicle is a rail vehicle;
a user of the mobile device points a camera of the mobile device at a track in a station before the vehicle arrives at the station;
a representation of the vehicle that reproduces an expected stationary position of the vehicle on the track and is correct in terms of its position and perspective is overlaid onto a display unit of the mobile device; and
the travel information includes an item of information relating to the expected stationary position of the vehicle on the track.

26. The method according to claim 25, which further comprises:
displaying information relating to seat occupancy of the vehicle in the representation of the vehicle; and
overlaying free seats onto the representation of the vehicle with color highlighting and in a correct position.

27. The method according to claim 16, wherein the travel information includes locating information for locating a reserved seat, locating a car of the vehicle and/or locating an entrance door of the vehicle closest to the mobile device, and the locating information is output by way of the mobile device.

28. The method according to claim 27, wherein the locating information depends on a location and/or orientation of the mobile device and relates to an expected stationary position of the vehicle in a station.

29. The method according to claim 16, wherein the travel information includes information on which type of help and/or which aids an individual needs to be able to reach the vehicle and/or board the vehicle, and the information is transmitted from the mobile device to the central computer.

30. The method according to claim 17, which further comprises selecting the object from the group consisting of a display board and a ticket.

31. The method according to claim 23, wherein the announcement is in a form of a loudspeaker transmission through a station loudspeaker.

32. An information system for providing travel information, the information system comprising:
a mobile device;
a central computer;
said mobile device automatically determining which vehicle the travel information is provided for; and
the travel information relating to the vehicle is transferred between said central computer and said mobile device.
